(19) United States
(12) Patent Application Publication
(10) Pub. No.: US 2020/0349521 A1
(43) Pub. Date: Nov. 5, 2020

(54) SYSTEM AND METHOD FOR EMPLOYMENT DATA MANAGEMENT

(71) Applicant: MARCOMM Inc., Minneapolis, MN (US)

(72) Inventor: Benjamin R. Clark, Minneapolis, MN (US)

(21) Appl. No.: 16/856,585

(22) Filed: Apr. 23, 2020

Related U.S. Application Data
(60) Provisional application No. 62/842,171, filed on May 2, 2019.

(51) Int. Cl. G06Q 10/10; G06F 16/9535; G06F 16/9538; G08B 21/18

(52) U.S. Cl. CPC G06Q 10/1053; G08B 21/182; G06F 16/9538; G06F 16/9535

(57) ABSTRACT

A system and method for managing employment data and matching job seekers with hiring managers is disclosed. The system and method can include a computing device having a processing device and a memory drive where the computing device is in communication with a web-based processing system. A hiring manager interface and a job seeker interface are in communication with the web-based processing system. The job seeker interface can allow the job seeker to input and store a profile that contains at least one of the job seeker's employment preferences, job knowledge, job-related competencies, experiences, and skill levels. The system and method can also include an algorithm that allows the computing device to assign a predictive match score to the job seeker's input by matching the hiring manager's requirement list with the job seeker's profile. The match score assigned by the algorithm can be presented to the hiring manager through a hiring manager interface.

### RELATED APPLICATIONS

The present application claims the benefit of U.S. Provisional Patent Application Ser. No. 62/842,171 filed May 2, 2019, entitled SYSTEM AND METHOD FOR EMPLOYENT DATA MANAGEMENT”, currently pending, which is incorporated herein by reference in its entirety.

### FIELD

The present disclosure relates to systems and methods for job matching, and more particularly, to computer-based systems and methods for assessing and scoring the competencies of job seekers in relation to a specific job posting.

### BACKGROUND

One way in which employers try to attract potentially suitable job candidates is to advertise available opportunities on internet-based job boards. This hiring process typically involves posting individual job descriptions in which each description includes a listing of preferred qualifications and qualities. These job descriptions are then displayed so that interested job seekers can apply. This process may result in a large number of applications being received for a given opportunity and there is no assurance that the applicants will be quality applicants having the preferred qualifications and qualities. Thus, the hiring process can become highly time-consuming and expensive for employers. Additionally, job seekers often become frustrated by the need to scour job boards for hours simply to identify interesting job openings that meet their career goals, preferred compensation and location.

Computer-based systems and methods for identifying suitable job candidates for specific job openings are known, however, improvement in data analysis that measures job seekers' professional experiences, including skills and technical knowledge coupled with personal job preferences, are needed to improve the efficacy of matching job candidates to job openings.

### SUMMARY

Disclosed herein is a computer-based system and method for facilitating identification of job candidates for specific job openings. In one aspect, a system for managing employment data is disclosed that includes a web-based processing system in communication with a hiring manager computer device. The hiring manager computer device can have an interface that can allow a hiring manger to create a requirement list for available jobs. The system can also include a job seeker computing device also in communication with the web-based processing system. The job seeker computing system can have an interface allows the job seeker to input and store a personal profile. The disclosed system can also include an algorithm for data analysis that allows the job seeker computing device to assign a predictive match score to the job seeker's input, and

wherein the predictive match score assigned by the algorithm is presented to the hiring manager through the hiring manager computing device through the hiring manager's interface.

In another aspect, method for managing employment data is disclosed that can include allowing a hiring manager to create a requirement list for an available job on a hiring computer device interface. The disclosed method can also include allowing a job seeker to input and store a personal profile on a job seeker computer device interface. The hiring computer device interface and the job seeker computer device interface can be in communication with a web-based processing system. Additionally, the disclosed method can allow an algorithm to run an algorithm that can assign a match score to the job seeker by matching one or more elements of the hiring manager's requirement list with elements in the job seeker's profile. The disclosed method then can present the match score of the job seeker to the hiring manager when the match score of the job seeker exceeds a threshold contained in the requirement list of the hiring manager.

The above summary is not intended to describe each disclosed embodiment of every implementation of the present disclosure. The brief description of the drawings and the detailed description which follow more particularly exemplifies illustrative embodiments.

### BRIEF DESCRIPTION OF DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings in which:

FIG. 1 is a schematic block diagram according to an embodiment of the disclosed system and method;

FIG. 2 is a schematic of an embodiment of the disclosed method.

In this application, the terms:

“algorithm” refers to proprietary software that performs data analysis of job seeker input, assigns weighted scores to each input item as it pertains to the job seeker job preferences, and comes up with a total match score that can be presented to a hiring manager if the total match score exceeds a threshold determined by the hiring manager;

“dashboard” refers to an interactive visual display on a computer interface; and

“job seeker's preferences” refers to the wants, needs, or requirements of the job seeker used for matching against the job requirements posted in the system.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or sprit of the present disclosure. The following detailed description, therefore, is not to be taken in a limiting sense.

A system and method described herein which can be directed toward a hiring process in which job seekers can be matched with job opportunities using predictive match scores. The predictive match scores can be assigned by a web-based computer processing system that is in communication with a hiring manager interface and a job seeker interface.

The hiring manager can be an employer, human resources individual employed by a company or a third-party recruiter seeking candidates on behalf of the employer. The hiring manager can include any person with hiring authority. In some embodiments, the hiring manager can be an executive, a director, a manager, a human resources manager, or even another employee trying to hire an assistant. When the hiring manager has a job opportunity, he/she can use the hiring manager interface.

The hiring manager interface can allow the hiring manager to input and store information related to the job opportunity. This information (requirement list) can include, for example, general skills for the job opportunity, specific job skill for the job opportunity, and tech/software skills for the job opportunity. This hiring manager can also input general information relating to the job opportunity. Exemplary information that can be input by the hiring manger can include company information, company size, the industry or industries the company is in, the location of the job, the role or function of the job, the engagement type of the job (permanent, contract, or project-based), the employment type (full-time or part time), the compensation for the job, whether the job allows for remote access or telecommuting, the minimum educational requirements for the job, and the preferred years of experience. The hiring manager can indicate, for each piece of entered information, whether or not the qualities of the job opportunity are required or preferred to perform the job.

The job seeker can be anyone seeking a job opportunity. A job seekers can become a job candidate for a given job opportunity, if he or she is highly matched and a best fit for a given job opening as is typically determined by meeting some minimum requirement or total match score threshold. Similar to the hiring manager, the job seeker can create a profile by inputting and storing information relating to his or her job wants or preferences using a job seeker's interface that is also in communication with the web-based processing system. Typical pieces of information that can be input into the job seeker's profile can include the job seeker's legal status, engagement preference (see above), employment type, duration of job if contract or project-based), geographical range preference, whether or not remote working is preferred or required, the most preferred roles or job functions, years of experience, company size preference, compensation type preferred (salary/hourly/other and range), industry preference, and education.

When the job seeker profile has been entered into the system, the system can perform a competency assessment of the job seeker by presenting the job seeker with a list of questions (typically, about 50-70 questions) of general skills, specific job skills, and tech./software skills that best support the role/job function that the job seeker is interested in reviewing. The list of questions that is offered to the job seeker can be a list that is preselected by the system based upon the job being applied for and the input from the job seeker. The job seeker can then input into the system a competency self-assessment rating of Expert, Proficient, Familiar, or None to each of the above skills based upon answering the questions.

The disclosed system also can include an algorithm that can evaluate the job seeker's information entered into the job seeker's interface and the competency self-assessment to create a match score for each job-related competency that relates to the type of job applied for. The algorithm can take the input from the job seeker into the system and can add weighting factors depending upon the importance of each of the job-related competencies and come up with individual match scores for each job-related competency as well as a total predictive match score for the job seeker relative to the type of preferred job in the job seekers profile.

For a job seeker to be eligible to review emerging job opportunities certain minimum preferences should be met. For example, the engagement type and employment type entered by the job seeker should be an exact match with the engagement type and employment type in the hiring manager's job profile. Additionally, minimum salary preferences by a job seeker should be within a range of the compensation posted for the job for which the job seeker is applying. Also, for example, if the job is not designated as a remote engagement, the job seeker should be within a specified distance from a job site.

The algorithm can determine if the job seeker is eligible for the job opportunity posted by the hiring manager. If the job seeker is found to be eligible for the job opportunity, then the algorithm can categorize the job seeker's input information in his or her profile into sections for analysis. During evaluation of this information, the algorithm can assign a predictive match score for each section. The predictive match score for each section may be assigned a weighting factor by the algorithm. Some of the sections of the profile analyzed may have subsections or subcategories, each assigned a relative weight by the algorithm as it relates to the overall weight of the respective section. For example, one section may build a competency score based upon the job seeker's input information relating to years of experience as compared to the years of experience listed by the hiring manager listed in his or her input relating to a job opportunity. This section may also rate the job seeker's aptitude in general skills, job skills, and technical skills that support the specific job function (that has been inputted into the system by the hiring manager).

For example, another section of the job seeker's input information that is analyzed by the algorithm may include the job seeker's salary preferences. The algorithm may assign a match score based upon the job seeker's salary requirements or preferences, and the range of salary posted for the job by the hiring manager.

For example, a third section may include the job seeker's personal preferences. These wants or preferences may include commuter tolerance (distance from work site), company size, and industry preferences. The job seeker's preferences in this section may also be matched to those posted by the hiring manager. The algorithm may also assign a weighted score for this section of the job seeker's input information. There may be more sections of the job seeker's input data that the algorithm evaluates separately depending upon the job description input from the hiring manager.

Finally, after each section has been analyzed and assigned a predictive match score, a total match score is calculated by the algorithm. The evaluation of the job seeker's information in comparison with that of the job opportunity can be performed without the knowledge of the hiring manager. If the total match score of a job opportunity (sometime in combination with section match scores) exceeds a threshold value set by the hiring manager or the algorithm the job seeker will be informed of the match. The job seeker can then decide whether or not to apply for the job. If the job seeker declines to apply for the job, the hiring manager is never informed about identity of the job seeker or the evaluation by the algorithm.

The information on job-related competencies, including the individual and total match scores from the algorithm can then be sent back to the job seeker interface (usually a portable electronic device such as a smart phone, tablet, or personal computer) for the job seeker to review. This information relates to job-related competencies for jobs that might be available and posted from a hiring manager. But, at this point, neither the identity or nor the data from the job seeker is available for the hiring manager to view. These data are kept in confidence in the system.

The job seeker can see his or her match scores and the total match score for a particular job listed on the system (on a job card) and can then decide to apply or to decline application for the job with a simple selection on the job seeker interface. If the job seeker declines application for the job, no information is sent to the hiring manager. The job seeker remains anonymous to the hiring manager.

If, however, the job seeker decides to apply for the job, his information is sent to a dashboard that the hiring manager can review. The hiring manager can then be made aware that there is a job seeker that meets his criteria posted for the job including meeting the predictive match score filter limit. At this point, any clue as to the job seeker's name, age, gender, ethnicity, or sexual orientation are withheld (promoting equal opportunity hiring practices).

If the job seeker preferences to proceed to apply for the job, he or she may allow the hiring manager to review a sanitized profile provided by the system. Any clue as to the job seeker's name, age, gender, ethnicity, or sexual orientation care withheld from the hiring manager at this point. Based upon the match scores provided to the hiring manager, the hiring manager can choose to unlock the profile of the job seeker and proceed to communicate directly with the job seeker. The process of unlocking the profile may involve paying a fee for access to this information.

If the hiring manager wants to proceed to make the job seeker a candidate for an open position based upon the job seeker's match scores and employment preferences, the hiring manager can unlock information stored in the system. This information can include additional job seeker insights and contact information. In some embodiments, the hiring manager might have to pay a fee to unlock this information. After the hiring manager has all of the information from the system, he/she may proceed with interviews and other contact activities of his or her own choosing.

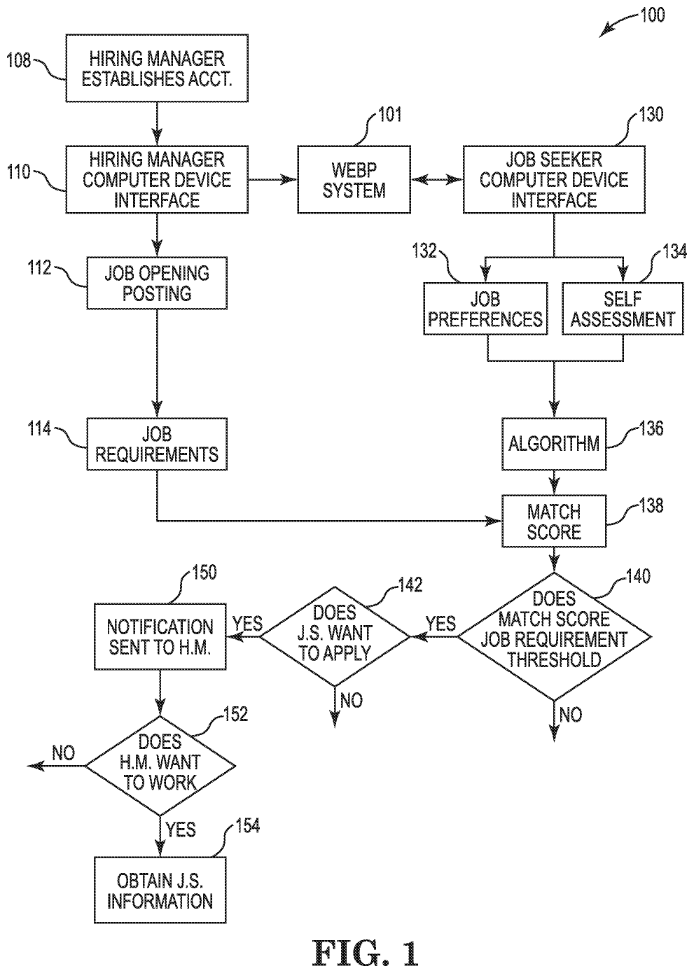

Embodiments of the system and method presented herein are illustrated in part by looking at the figures. FIG. 1 is a schematic block diagram according to an embodiment of the disclosed system. System 100 shows web-based processing system 101 that is in communication with hiring manager computer device interface 110 and job seeker computer device interface 130. To use system 100, a hiring manager can establish an account 108 that allows his or her access to system 100 through hiring manager computer device interface 110. The hiring manager can then post a job opening 112 on the system and post job requirements (preferences) 114 on the system. A job seeker can independently list job preferences 132 into the system through job seeker computer device interface 130. The job seeker also completes self-assessment 134 and rates his or her qualities relating to a series of questions posed by the system. Input from job requirements 132 posted by the job seeker and the answers to self-assessment 134 goes into algorithm 136. Algorithm 136 assigns match score values for the job seeker based upon his or her input. Algorithm 136 produces one or more match score 138 for each job seeker attribute as they apply to a job position that might be available in the system. Any job requirements 114 that have been posted into system 100 by a hiring manager can then compare threshold requirements for match scores for a job posting as shown in 140. If there is a match with the job seeker, the job seeker then decides whether or not to apply for the job 142. If the answer is “yes” then notification is sent to the hiring manager 150 informing the hiring manager that a job seeker meets his or her minimum job requirements and has applied for the job. The hiring manager then can decide to unlock the job seeker information 152 and if the answer is “yes” the hiring manager can pay a fee to access the job seeker's information stored on the system and then can proceed to initiate his or her own hiring process.

In another aspect, method for managing employment data is disclosed that can include allowing a hiring manager to create a requirement list for an available job on a hiring computer device interface. The disclosed method can also include allowing a job seeker to input and store a personal profile on a job seeker computer device interface. The hiring computer device interface and the job seeker computer device interface can be in communication with a web-based processing system. Additionally, the disclosed method can allow an algorithm to run an algorithm that can assign a match score to the job seeker by matching one or more elements of the hiring manager's requirement list with elements in the job seeker's profile. The disclosed method then can present the match score of the job seeker to the hiring manager when the match score of the job seeker exceeds a threshold contained in the requirement list of the hiring manager.

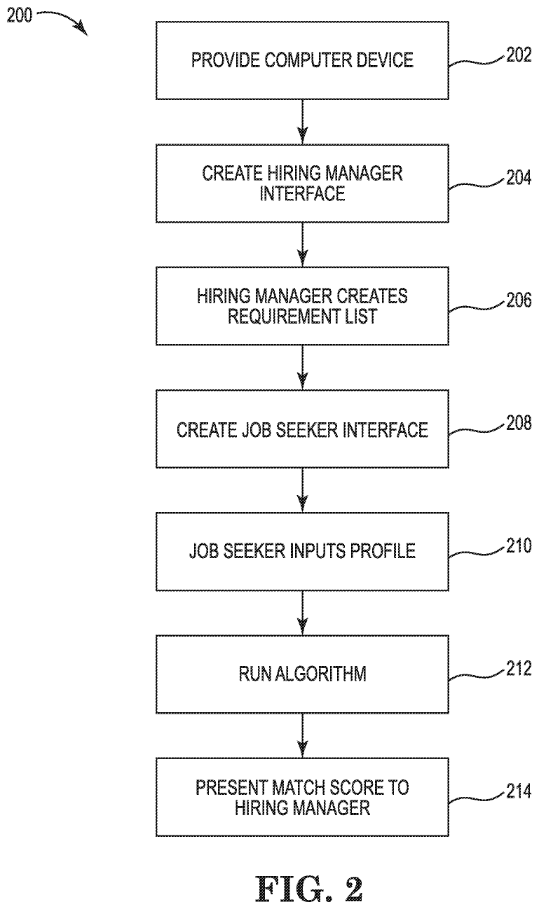

Illustrative embodiments of the disclosed method of managing employment data and matching job seekers with hiring managers are shown, in part, in FIG. 2. FIG. 2 illustrates method 200 according to the instant disclosure. The elements illustrated in FIG. 2 are not necessarily listed in the order in which they may occur. The disclosed method can include providing computing device 202. The computing device can have a processing device and a memory drive. The disclosed computing device can be a permanent computing system such as a desktop computer or a computer network. Alternatively, the disclosed computing device can include any of a number of portable electronic computing device such as, but not limited to, for example, a laptop computer, a table computer, or a smart phone. Computing device 202 is in communication with a web-based processing system.

The method includes creating hiring manager interface 204. The hiring manager interface is also in communication with the web-based processing system. The hiring manager interface can allow the hiring manager to create requirement list 206 for one or more available jobs for which the hiring manager is looking for qualified applicants. In an additional step, the method also includes creating job seeker interface 208 in communication with the web-based processing system. The job seeker interface can allow a job seeker to input a profile 210 that contains at least one of the job seeker's employment preferences, job knowledge and skills, job-related competencies, experiences and skill levels. The job seeker profile can include input that has been disclosed above in describing the system for managing employment data.

The disclosed method includes running algorithm 212 that assigns weighted scores to the job seeker's inputs and matches them according to preprogramed instructions. The algorithm weights each component of the job seeker's inputs according to the type of job for which the job seeker is applying. The algorithm also assigns predictive match score 214 to the hiring manager if the predictive match score meets minimum requirements of the job posting.

Finally, but not illustrated, the job seeker can be informed of the predictive match score and, if it meets the minimum requirements of the job posting, the job seeker can elect to have the system inform the hiring manager of the job seeker's identity and match scores. If the hiring manager is interested he or she can then unlock the job seeker's stored information as shown in FIG. 1

Various modifications and alterations to this disclosure will become apparent to those skilled in the art without departing from the scope and spirit of this disclosure. It should be understood that this disclosure is not intended to be unduly limited by the illustrative embodiments set forth herein and that such embodiments are presented by way of example only with the scope of the disclosure intended to be limited only by the claims set forth herein as follows. All references cited in this disclosure are herein incorporated by reference in their entirety.

What is claimed is:

1. A system for managing employment data comprising a web-based processing system in communication that includes:
a hiring manager computing device wherein the hiring computing device has an interface that allows a hiring manager to create a requirement list for available jobs;
a job seeker computing device wherein the job seeker computing system has an interface allows a job seeker to input and store a personal profile and;
an algorithm that allows the job seeker computing device to assign a predictive match score to the job seeker's input, and
wherein the predictive match score assigned by the algorithm is presented to the hiring manager through the hiring manager computing device through the hiring manager's interface.

2. A system for managing employment data according to claim 1, wherein the personal profile comprises at least one of the job seeker's employment preferences, job knowledge, job-related competencies, experiences, and skill levels.

2. A system for managing employment data according to claim 1, wherein the job seeker's computing device comprises a portable electronic device.

3. A system for managing employment data according to claim 2, wherein the portable electronic device comprises a laptop computer, a smartphone, or a tablet.

4. A system for managing employment data according to claim 1, wherein the job seeker does a competency self-assessment of the job seeker's profile.

5. A system for managing employment data according to claim 4, wherein the competency self-assessment comprises knowledge, years of experience, job-related competencies, or experience.

6. A system for managing employment data according to claim 1, wherein the requirement list of the hiring manager comprises at least one of a job description, a table of job-related competencies, a table of weighting factors, and a match score threshold.

7. A system for managing employment data according to claim 6 further comprising a notification sent to the hiring manager when the match score of the job seeker is greater than the match score threshold.

8. The hiring manager can unlock additional job seeker insights and contact information also stored in the job seeker's profile when the match score of the job seeker is above a threshold determined by the hiring manager.

9. A system for managing employment data according to claim 1, wherein the job seeker interface comprises a dashboard.

10. A method for managing employment data comprising:
providing a computing device having a processing device and a memory drive, wherein the computing device is in communication with a web-based processing system;
creating a hiring manager interface in communication with the web-based processing system;
the hiring manager creating a requirement list for available jobs;
creating a job seeker interface also in communication with the web-based processing system;
the job seeker inputting a profile that contains least one of the job seeker's employment preferences, job knowledge, job-related competencies, experiences, and skill levels;
running an algorithm that assigns a match score to the job seeker by matching one or more elements of the hiring manager's requirement list with elements in the job seeker's profile; and
presenting the match score of the job seeker to the hiring manager when the match score if the job seeker exceeds a threshold contained in the requirement list of the hiring manager.
